(19) United States
(12) Patent Application Publication
(10) Pub. No.: US 2026/0147093 A1
(43) Pub. Date: May 28, 2026

(54) LIDAR System Having Optical Components Coupled Together with Solder

(71) Applicant: Aurora Operations, Inc., Pittsburgh, PA (US)

(72) Inventor: Lei Wang, Fremont, CA (US)

(21) Appl. No.: 18/962,692

(22) Filed: Nov. 27, 2024

(51) Int. Cl. G01S 7/481; G01S 17/93; G02B 6/42

(52) U.S. Cl. CPC G01S 7/481; G01S 17/93; G02B 6/4224; G02B 6/4238; G02B 6/4244; G02B 6/4269; G02B 6/4272

(57) ABSTRACT

A method for manufacturing a semiconductor-based light detection and ranging (LIDAR) system for a vehicle, includes: providing a first optical component with a through-hole disposed in a central portion of the first optical component and solder disposed on a first portion of the first optical component which is adjacent to the through-hole; providing a second optical component; coupling the first optical component to the second optical component in an alignment operation in which the second optical component at least partially covers the through-hole, wherein after the alignment operation, the solder disposed on the first portion of the first optical component is not in contact with the second optical component; and applying heat to the solder to cause the solder to flow toward the second optical component and to come into contact with the second optical component.

### CROSS-REFERENCE TO RELATED APPLICATIONS

This application is related to the following U.S. application which is filed concurrently herewith and is incorporated by reference herein in its entirety for all purposes: Attorney Docket: AUR-2056-2, titled “LIDAR SYSTEM AND MANUFACTURING METHOD HAVING SEMICONDUCTOR-BASED OPTICAL COMPONENTS COUPLED TOGETHER WITH SOLDER”.

### BACKGROUND

Light Detection and Ranging (LIDAR) systems use lasers to create three-dimensional representations of surrounding environments. A LIDAR system includes at least one emitter paired with a receiver to form a channel, though an array of channels may be used to expand the field of view of the LIDAR system. During operation, each channel emits a laser beam into the environment. The laser beam reflects off of an object within the surrounding environment, and the reflected laser beam is detected by the receiver. A single channel provides a single point of ranging information. Collectively, channels are combined to create a point cloud that corresponds to a three-dimensional representation of the surrounding environment.

The emitter and/or receiver often includes photonic circuitry formed on a semiconductor substrate such as a silicon die. Silicon photonics dies can provide for precise formation of the photonic circuitry through, for example, photolithography. Other optical components of a LIDAR system may also be formed on semiconductor substrates, while still others are formed on or connected to components made using other semiconductor materials such as, for example, a group III-V semiconductor, gallium arsenide (GaAs), and/or other suitable materials.

### SUMMARY

Aspects and advantages of implementations of the disclosure will be set forth in part in the following description, or may be learned from the description, or may be learned through practice of the implementations.

Example aspects of the disclosure also relate to a LIDAR system including a plurality of optical components which are coupled together using solder. Example aspects of the disclosure also relate to a method of manufacturing a LIDAR system (e.g., a semiconductor optical system for a semiconductor-based LIDAR system for a vehicle), the semiconductor optical system (e.g., a semiconductor optical assembly, a photonics module, etc.) having the optical components which are coupled together using solder.

To achieve the integration of many optics and photonic components into small form factor modules or systems, an integrated LIDAR module and multiple semiconductor chips (silicon photonic chips, III-V chips, etc.) may be coupled directly together (e.g., butt-coupled or edge-coupled). For example, in optical and optoelectronic packaging, direct optical butt-coupling (also referred to as edge-coupling) may be used to couple a first waveguide to a second waveguide by providing (depositing) solder onto a surface of a first optical component and heating the solder to bond the first optical component to a second optical component. An alignment accuracy requirement (specification) may be satisfied according to examples of the disclosure.

The integration of laser diodes (LD) and/or semiconductor optical amplifier (SOA) chips with silicon photonics integrated circuit (Si PIC) chips can be achieved with flip-chip bonding, resulting in sub-micron in-plane alignment accuracy that can be necessary for optical coupling between waveguides on various chips. However, the out-of-plane alignment between Si PIC chips and LD/SOA chips can be difficult to achieve without active alignment, and without maintaining a bonding of the components with an adhesive (e.g., an organic adhesive such as epoxy bonding). Other challenges include heat dissipation for high power LD and/or SOA arrays and thermal interference to temperature sensitive devices in the Si PIC. Accordingly, optical components in a LIDAR system may not be sufficiently bonded together, and alignment issues (e.g., alignment accuracy) between the optical components may be encountered.

According to example embodiments of the disclosure, a LIDAR system includes a plurality of optical components including a first optical component and a second optical component which are coupled together via application of solder to the first optical component. Examples of the disclosure further relate to a method of manufacturing a LIDAR system (e.g., a semiconductor optical system for a semiconductor-based LIDAR system for a vehicle), the semiconductor optical system (e.g., a semiconductor optical assembly, a photonics module, etc.) having the first optical component and the second optical component which are coupled together via application of solder to the first optical component.

According to example embodiments of the disclosure, submicron out-of-plane alignment accuracy and effective heat dissipation for high power LD and/or SOA arrays can be achieved without requiring active alignment or by reducing the need for active alignment operations.

In some implementations, a LIDAR system includes a first optical component and a second optical component which are coupled together by applying solder in a particular manner to the first optical component while obtaining a three-dimensional alignment accuracy in the sub-micrometer range. For example, a method of assembling a first optical component and a second optical component (e.g., semiconductor optoelectronic and photonic chips) includes depositing solder on a first portion of the first optical component and implementing a flip chip operation (e.g., via flip-chip machinery or mechanisms including flip-chip bonders, grippers, etc.) to couple the first optical component to a second optical component in an alignment operation. After the first optical component is coupled to the second optical component via the flip chip operation, the solder on the first portion of the first optical component is not in contact with (e.g., is spaced apart from) the second optical component. The method further includes applying heat to the solder to cause the solder to flow toward and/or expand in a direction toward the second optical component and to come into contact with the second optical component.

In some implementations, the first optical component can include a silicon photonics integrated circuit (Si PIC) chip and the second optical component can include a high power semiconductor laser diode (LD) array chip.

In some implementations, the alignment operation includes aligning the first optical component with the second optical component by reference to fiducial marks (etched fiducial marks) that are disposed on mating surfaces of the first optical component and the second optical component, for in-plane alignment. In some implementations, the alignment operation includes aligning the first optical component with the second optical component using mechanical stops (pedestals) that are disposed on the first optical component, for out-of-plane alignment. The mechanical stops can be disposed adjacent to the first portion where the solder is applied. The first portion can include an under bump metal pad provided on a surface of a dielectric material (e.g., silicon dioxide). When the solder is applied to the first portion, the solder is oversized compared to the first portion (the under bump metal pad). For example, the solder has a greater area or perimeter (or diameter) than the first portion. When the heat is applied to the solder so as to bond the first optical component and second optical component, the solder can shrink its footprint and expand in height (e.g., in a direction toward the second optical component). For example, the solder can have the same, or substantially same area or perimeter (or diameter), as the first portion. Further, after the solder expands in the direction toward the second optical component, the solder can have a same height, or substantially same height, as the mechanical stop.

In some implementations, one or more heat spreaders may be coupled to one or more sides of the second optical component (the laser diode array chip). For example, the one or more heat spreaders may be formed by plated gold film. The first optical component (the Si PIC chip) can include a through-hole in which at least one heat spreader and optionally the second optical component can be inserted, which can provide a compact configuration. The second optical component having the one or more heat spreaders coupled thereto can be bonded to the first optical component via the solder and be supported by the mechanical stops, with optical facets of the first and second optical components facing each other such that waveguides of the first optical component are aligned with emitters of the second optical component. Therefore, the disclosed optical system for a LIDAR system and method for manufacturing the same can be implemented for coupling optical components together while achieving submicron out-of-plane alignment accuracy and effective heat dissipation for high power laser diode arrays.

In some implementations, the second optical component having the one or more heat spreaders coupled thereto and which is bonded to the first optical component via the solder, can further be coupled to a carrier (e.g., via an adhesive such as glue). For example, the carrier can be connected electrically and thermally to one of the heat spreaders (e.g., through chip vias filled with metal for electrical conductivity) such that the carrier serves as both a heat sink and an electrical terminal for the whole device.

The disclosed optical system and method can be implemented to ensure that the optical components are securely and accurately coupled together, thereby improving the structural integrity of the optical components of the optical system. Further, according to the optical systems and methods described herein, an alignment of optical components can be improved compared to previous methods.

Example aspects of the disclosure are directed to LIDAR systems for autonomous vehicles. As further described herein, the LIDAR systems can be used by various devices and platforms (e.g., robotic platforms, etc.) to improve the ability of the devices and platforms to perceive their environment and perform functions in response thereto (e.g., autonomously navigating through the environment).

An autonomous vehicle (AV) can include a LIDAR system to assist the AV in perceiving its environment and navigating its environment. The LIDAR system can include a transceiver having a transmitter and receiver. The transmitter can condition a light beam (e.g., a laser beam) to be emitted by the LIDAR system into its environment. Similarly, the receiver can provide for receiving the light beam after it is emitted into the environment of the LIDAR system and reflected by objects in the environment. The receiver can provide the received beam to downstream components of the LIDAR system for processing, which can provide for the AV to perceive its environment. Because of the correlation between the transmitted beam and received beam, the transmitter and receiver may generally be placed in a tightly controlled positional relationship. For instance, the portion of the transmitter that emits the beam can be positioned near the portion of the receiver that receives the beam. In addition, some LIDAR systems such as coherent LIDAR systems can utilize a reference signal, such as a local oscillator (LO) signal, which passes from the transmitter to receiver without being emitted into the environment of the LIDAR system. For instance, this reference signal may be combined with the received beam to denoise or otherwise process the received beam to extract useful information. For instance, the LIDAR system can determine a distance to the object and/or velocity of the object based on the reflected beam.

The disclosure provides an improved LIDAR system, such as a coherent LIDAR system, which includes components which are properly aligned, coupled together, or positioned according to specification or tolerance requirements.

A coupling system and a LIDAR system according to the disclosure can provide numerous technical effects and benefits. For example, a coupling method implemented by a coupling system as described herein can ensure that semiconductor optical devices implemented in a LIDAR system operate (function) according to specifications and are positioned within a LIDAR system (e.g. LIDAR system) according to design or specification requirements.

For instance, the LIDAR systems manufactured according to the disclosure can provide improved accuracy of object detections through properly aligned or coupled components (e.g., properly aligned semiconductor optical devices). In addition, when a plurality of semiconductor optical devices are provided, the semiconductor optical devices can be coupled together with respect to one another according to the methods described herein, thereby improving the quality of the LIDAR system (e.g., LIDAR system). In this manner, LIDAR systems according to the disclosure can provide improved performance compared to some existing LIDAR systems.

Example aspects of the disclosure provide an example method for manufacturing a semiconductor-based light detection and ranging (LIDAR) system for a vehicle. The example method includes: providing a first optical component with a through-hole disposed in a central portion of the first optical component and solder disposed on a first portion of the first optical component which is adjacent to the through-hole; providing a second optical component; coupling the first optical component to the second optical component in an alignment operation in which the second optical component at least partially covers the through-hole, wherein after the alignment operation, the solder disposed on the first portion of the first optical component is not in contact with the second optical component; and applying heat to the solder to cause the solder to flow toward the second optical component and to come into contact with the second optical component.

In some implementations, the first optical component includes a first recess disposed on a first side of the through-hole and a second recess disposed on a second side of the through-hole, the first portion of the first optical component is disposed on the first side of the through-hole, and the first optical component includes additional solder disposed on a second portion of the first optical component which is disposed on the second side of the through-hole.

In some implementations, the first recess and the second recess border the through-hole.

In some implementations, the first portion of the first optical component is an under bump metal pad, an area of the under bump metal pad is smaller than an area of the solder before the heat is applied to the solder, and the area of the under bump metal pad is substantially the same as the area of the solder after the heat is applied to the solder.

In some implementations, the first optical component includes a first recess bordering a first side of the through-hole and a second recess bordering a second side of the through-hole, solder is disposed at a first plurality of locations in the first recess, and additional solder is disposed at a second plurality of locations in the second recess.

In some implementations, applying the heat to the solder causes the solder to spread on a metal trace disposed on a surface of the second optical component, and to move into a gap between the first optical component and the second optical component via a capillary force.

In some implementations, the first optical component includes a first recess disposed on a first side of the through-hole and a second recess disposed on a second side of the through-hole, and the alignment operation comprises aligning the first optical component with the second optical component using a first plurality of mechanical stops disposed in the first recess and a second plurality of mechanical stops disposed in the second recess.

In some implementations, a first mechanical stop among the first plurality of mechanical stops is disposed adjacent to the first portion of the first optical component, a height of the first mechanical stop is greater than a height of the solder before the heat is applied to the solder, and the height of the first mechanical stop is substantially the same as the height of the solder after the heat is applied to the solder.

In some implementations, the first optical component includes a silicon photonics integrated circuit chip and the second optical component includes a laser diode array chip.

In some implementations, the method includes coupling a first heat spreader to a first side of the laser diode array chip, wherein the alignment operation comprises a flip chip operation comprising: flipping over the laser diode array chip having the first heat spreader coupled thereto, coupling a second heat spreader to a second side of the laser diode array chip, and coupling the silicon photonics integrated circuit chip to the laser diode array chip by inserting the laser diode array chip having the first heat spreader and the second heat spreader coupled thereto, in the through-hole.

In some implementations, a surface area of a side of the first heat spreader facing the first side of the laser diode array chip is greater than a surface area of a side of the second heat spreader facing the second side of the laser diode array chip.

In some implementations, applying the heat to the solder comprises locally heating the first portion of the first optical component.

In some implementations, applying the heat to the solder comprises globally heating the first optical component.

Example aspects of the disclosure provide a semiconductor-based light detection and ranging (LIDAR) system. The example LIDAR system includes: an optical system, comprising: a first optical component including a through-hole disposed in a central portion thereof, a first recess disposed on a first side of the through-hole, and a second recess disposed on a second side of the through-hole, the first optical component including: first solder disposed on each of a first plurality of under bump metal pads disposed in the first recess, second solder disposed on each of a second plurality of under bump metal pads disposed in the second recess, one or more first mechanical stops disposed adjacent to each of the first plurality of under bump metal pads, and one or more second mechanical stops disposed adjacent to each of the second plurality of under bump metal pads; and a second optical component coupled to the first optical component and at least partially covering the through-hole, the second optical component including: first portions coupled to the first optical component via the first solder and the second solder, and second portions supported by the one or more first mechanical stops of the first optical component and the one or more second mechanical stops of the first optical component, and wherein an area of the first solder is substantially the same as an area of a corresponding under bump metal pad on which the first solder is disposed among the first plurality of under bump metal pads, and a height of the first solder is substantially the same as a height of at least one mechanical stop of the one or more first mechanical stops extending in a direction toward the second optical component.

In some implementations, the first recess and the second recess border the through-hole.

In some implementations, the first optical component includes a silicon photonics integrated circuit chip and the second optical component includes a laser diode array chip.

In some implementations, the LIDAR system further includes a first heat spreader coupled to a first side of the laser diode array chip; and a second heat spreader coupled to a second side of the laser diode array chip, wherein the second side of the laser diode array chip faces toward the silicon photonics integrated circuit chip and the first heat spreader is disposed outside of the through-hole.

In some implementations, the first optical component further includes one or more waveguides, and the second optical component further includes one or more emitters aligned with the one or more waveguides.

Example aspects of the disclosure provide an example autonomous vehicle (AV) control system for a vehicle. The example AV control system for the vehicle includes one or more processors and the example LIDAR sensor system described herein.

Example aspects of the disclosure provide an example autonomous vehicle (AV). The example AV includes: an autonomous vehicle control system, the autonomous vehicle control system comprising one or more processors and a light detection and ranging (LIDAR) system, the LIDAR system comprising: an optical system, comprising: a first optical component including a through-hole disposed in a central portion thereof, a first recess disposed on a first side of the through-hole, and a second recess disposed on a second side of the through-hole, the first optical component further including: first solder disposed on each of a first plurality of under bump metal pads disposed in the first recess, second solder disposed on each of a second plurality of under bump metal pads disposed in the second recess, one or more first mechanical stops disposed adjacent to each of the first plurality of under bump metal pads, and one or more second mechanical stops disposed adjacent to each of the second plurality of under bump metal pads; and a second optical component coupled to the first optical component and at least partially covering the through-hole, the second optical component being configured to emit one or more beams to be directed toward an object in an environment of the autonomous vehicle via the first optical component, the second optical component including: first portions coupled to the first optical component via the first solder and the second solder, and second portions supported by the one or more first mechanical stops of the first optical component and the one or more second mechanical stops of the first optical component, wherein an area of the first solder is substantially the same as an area of a corresponding under bump metal pad on which the first solder is disposed among the first plurality of under bump metal pads, and a height of the first solder is substantially the same as a height of at least one mechanical stop of the one or more first mechanical stops extending in a direction toward the second optical component, a receiver configured to receive a reflected beam from the object and determine an object detection associated with the object; and an autonomous vehicle controller configured to control the autonomous vehicle based on the object detection associated with the object.

Other example aspects of the disclosure are directed to other systems, methods, vehicles, apparatuses, tangible non-transitory computer-readable media, and devices for motion prediction and/or operation of a device including a LIDAR system having a LIDAR module according to aspects of the disclosure.

These and other features, aspects and advantages of various implementations of the disclosure will become better understood with reference to the following description and appended claims. The accompanying drawings, which are incorporated in and constitute a part of this specification, illustrate implementations of the disclosure and, together with the description, serve to explain the related principles.

### BRIEF DESCRIPTION OF THE DRAWINGS

FIG. 1 depicts a block diagram of an example system according to some implementations of the disclosure.

FIG. 2 depicts a block diagram of an example LIDAR system according to some implementations of the disclosure.

FIGS. 3A-3D are views of an example first optical component for an example optical system for a LIDAR system, according to some implementations of the disclosure.

FIGS. 4A-4C are views of an example second optical component for an example optical system for a LIDAR system, according to some implementations of the disclosure.

FIGS. 5A-5E are views of an example optical system for a LIDAR system, according to some implementations of the disclosure.

FIGS. 6A-6B are views of example process operations for an optical system for a LIDAR system, according to some implementations of the disclosure.

FIGS. 7A-7D are views of an example optical system for a LIDAR system, according to some implementations of the disclosure.

FIGS. 8-9 illustrate flow diagrams of example, non-limiting computer-implemented methods, according to one or more example embodiments of the disclosure.

### DETAILED DESCRIPTION

The following describes the technology of this disclosure within the context of a LIDAR system and an autonomous vehicle for example purposes only. As described herein, the technology is not limited to an autonomous vehicle and can be implemented within other robotic and computing systems as well as various devices. For example, the systems and methods disclosed herein can be implemented in a variety of ways including, but not limited to, a computer-implemented method, an autonomous vehicle system, an autonomous vehicle control system, a robotic platform system, a general robotic device control system, a computing device, etc.

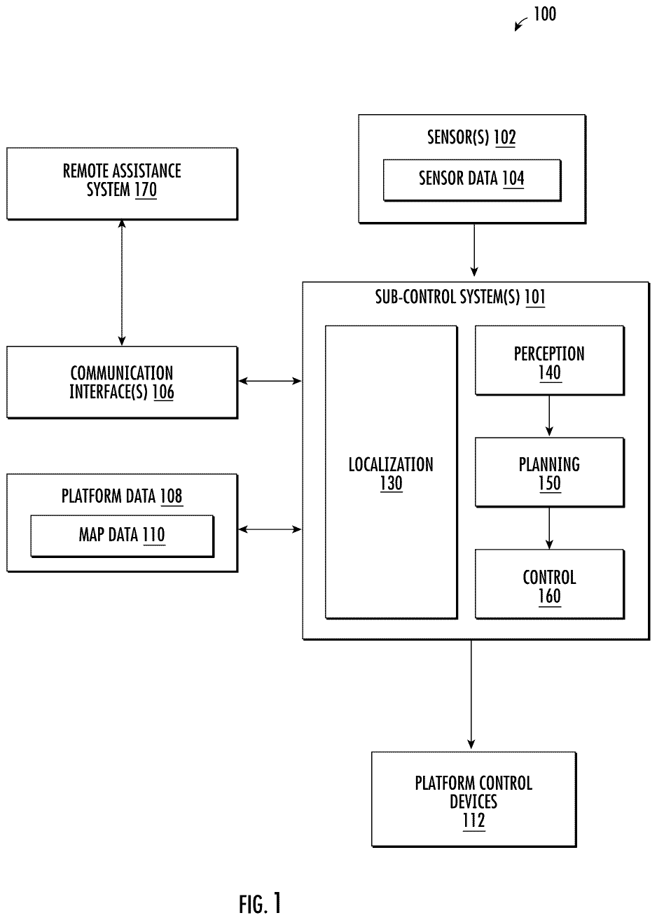

With reference to FIGS. 1-9, example implementations of the disclosure are discussed in further detail. FIG. 1 depicts a block diagram of an autonomous vehicle control system 100 for an autonomous vehicle according to some implementations of the disclosure. The autonomous vehicle control system 100 can be implemented by a computing system of an autonomous vehicle). The autonomous vehicle control system 100 can include one or more sub-control systems 101 that operate to obtain inputs from sensor(s) 102 or other input devices of the autonomous vehicle control system 100. In some implementations, the sub-control system(s) 101 can additionally obtain platform data 108 (e.g., map data 110) from local or remote storage. The sub-control system(s) 101 can generate control outputs for controlling the autonomous vehicle (e.g., through platform control devices 112, etc.) based on sensor data 104, map data 110, or other data. The sub-control system 101 may include different subsystems for performing various autonomy operations. The subsystems may include a localization system 130, a perception system 140, a planning system 150, and a control system 160. The localization system 130 can determine the location of the autonomous vehicle within its environment; the perception system 140 can detect, classify, and track objects and actors in the environment; the planning system 150 can determine a trajectory for the autonomous vehicle; and the control system 160 can translate the trajectory into vehicle controls for controlling the autonomous vehicle. The sub-control system(s) 101 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the sub-control system(s) 101 can be shared among its subsystems, or a subsystem can have a set of dedicated computing resources.

In some implementations, the autonomous vehicle control system 100 can be implemented for or by an autonomous vehicle (e.g., a ground-based autonomous vehicle). The autonomous vehicle control system 100 can perform various processing techniques on inputs (e.g., the sensor data 104, the map data 110) to perceive and understand the vehicle's surrounding environment and generate an appropriate set of control outputs to implement a vehicle motion plan (e.g., including one or more trajectories) for traversing the vehicle's surrounding environment. In some implementations, an autonomous vehicle implementing the autonomous vehicle control system 100 can drive, navigate, operate, etc. with minimal or no interaction from a human operator (e.g., driver, pilot, etc.).

In some implementations, the autonomous vehicle can be configured to operate in a plurality of operating modes. For instance, the autonomous vehicle can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous vehicle can operate in a semi-autonomous operating mode in which the autonomous vehicle can operate with some input from a human operator present in the autonomous vehicle (or a human operator that is remote from the autonomous platform). In some implementations, the autonomous vehicle can enter into a manual operating mode in which the autonomous vehicle is fully controllable by a human operator (e.g., human driver, etc.) and can be prohibited or disabled (e.g., temporary, permanently, etc.) from performing autonomous navigation (e.g., autonomous driving, etc.). The autonomous vehicle can be configured to operate in other modes such as, for example, park or sleep modes (e.g., for use between tasks such as waiting to provide a trip/service, recharging, etc.). In some implementations, the autonomous vehicle can implement vehicle operating assistance technology (e.g., collision mitigation system, power assist steering, etc.), for example, to help assist the human operator of the autonomous platform (e.g., while in a manual mode, etc.).

The autonomous vehicle control system 100 can be located onboard (e.g., on or within) an autonomous vehicle and can be configured to operate the autonomous vehicle in various environments. The environment may be a real-world environment or a simulated environment. In some implementations, one or more simulation computing devices can simulate one or more of: the sensors 102, the sensor data 104, communication interface(s) 106, the platform data 108, or the platform control devices 112 for simulating operation of the autonomous vehicle control system 100.

In some implementations, the sub-control system(s) 101 can communicate with one or more networks or other systems with communication interface(s) 106. The communication interface(s) 106 can include any suitable components for interfacing with one or more network(s), including, for example, transmitters, receivers, ports, controllers, antennas, or other suitable components that can help facilitate communication. In some implementations, the communication interface(s) 106 can include a plurality of components (e.g., antennas, transmitters, or receivers, etc.) that allow it to implement and utilize various communication techniques (e.g., multiple-input, multiple-output (MIMO) technology, etc.).

In some implementations, the sub-control system(s) 101 can use the communication interface(s) 106 to communicate with one or more computing devices that are remote from the autonomous vehicle over one or more network(s). For instance, in some examples, one or more inputs, data, or functionalities of the sub-control system(s) 101 can be supplemented or substituted by a remote system communicating over the communication interface(s) 106. For instance, in some implementations, the map data 110 can be downloaded over a network to a remote system using the communication interface(s) 106. In some examples, one or more of the localization system 130, the perception system 140, the planning system 150, or the control system 160 can be updated, influenced, nudged, communicated with, etc. by a remote system for assistance, maintenance, situational response override, management, etc.

The sensor(s) 102 can be located onboard the autonomous platform. In some implementations, the sensor(s) 102 can include one or more types of sensor(s). For instance, one or more sensors can include image capturing device(s) (e.g., visible spectrum cameras, infrared cameras, etc.). Additionally, or alternatively, the sensor(s) 102 can include one or more depth capturing device(s). For example, the sensor(s) 102 can include one or more LIDAR sensor(s) or Radio Detection and Ranging (RADAR) sensor(s). The sensor(s) 102 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 102 for capturing depth information can be fixed to a rotational device in order to rotate the sensor(s) 102 about an axis. The sensor(s) 102 can be rotated about the axis while capturing data in interval sector packets descriptive of different portions of a three-hundred-and-sixty-degree view of a surrounding environment of the autonomous platform. In some implementations, one or more of the sensor(s) 102 for capturing depth information can be solid state.

The sensor(s) 102 can be configured to capture the sensor data 104 indicating or otherwise being associated with at least a portion of the environment of the autonomous vehicle. The sensor data 104 can include image data (e.g., 2D camera data, video data, etc.), RADAR data, LIDAR data (e.g., 3D point cloud data, etc.), audio data, or other types of data. In some implementations, the sub-control system(s) 101 can obtain input from additional types of sensors, such as inertial measurement units (IMUs), altimeters, inclinometers, odometry devices, location or positioning devices (e.g., GPS, compass), wheel encoders, or other types of sensors. In some implementations, the sub-control system(s) 101 can obtain sensor data 104 associated with particular component(s) or system(s) of the autonomous vehicle. This sensor data 104 can indicate, for example, wheel speed, component temperatures, steering angle, cargo or passenger status, etc. In some implementations, the sub-control system(s) 101 can obtain sensor data 104 associated with ambient conditions, such as environmental or weather conditions. In some implementations, the sensor data 104 can include multi-modal sensor data. The multi-modal sensor data can be obtained by at least two different types of sensor(s) (e.g., of the sensors 102) and can indicate static and/or dynamic object(s) or actor(s) within an environment of the autonomous vehicle. The multi-modal sensor data can include at least two types of sensor data (e.g., camera and LIDAR data). In some implementations, the autonomous vehicle can utilize the sensor data 104 for sensors that are remote from (e.g., offboard) the autonomous vehicle. This can include for example, sensor data 104 captured by a different autonomous vehicle.

The sub-control system(s) 101 can obtain the map data 110 associated with an environment in which the autonomous vehicle was, is, or will be located. The map data 110 can provide information about an environment or a geographic area. For example, the map data 110 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous vehicle in understanding its surrounding environment and its relationship thereto. In some implementations, the map data 110 can include high-definition map information. Additionally, or alternatively, the map data 110 can include sparse map data (e.g., lane graphs, etc.). In some implementations, the sensor data 104 can be fused with or used to update the map data 110 in real time.

The sub-control system(s) 101 can include the localization system 130, which can provide an autonomous vehicle with an understanding of its location and orientation in an environment. In some examples, the localization system 130 can support one or more other subsystems of the sub-control system(s) 101, such as by providing a unified local reference frame for performing, e.g., perception operations, planning operations, or control operations.

In some implementations, the localization system 130 can determine the current position of the autonomous vehicle. A current position can include a global position (e.g., respecting a georeferenced anchor, etc.) or relative position (e.g., respecting objects in the environment, etc.). The localization system 130 can generally include or interface with any device or circuitry for analyzing a position or change in position of an autonomous vehicle. For example, the localization system 130 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous vehicle can be used by various subsystems of the sub-control system(s) 101 or provided to a remote computing system (e.g., using the communication interface(s) 106).

In some implementations, the localization system 130 can register relative positions of elements of a surrounding environment of the autonomous vehicle with recorded positions in the map data 110. For instance, the localization system 130 can process the sensor data 104 (e.g., LIDAR data, RADAR data, camera data, etc.) for aligning or otherwise registering to a map of the surrounding environment (e.g., from the map data 110) to understand the autonomous vehicle's position within that environment. Accordingly, in some implementations, the autonomous vehicle can identify its position within the surrounding environment (e.g., across six axes, etc.) based on a search over the map data 110. In some implementations, given an initial location, the localization system 130 can update the autonomous vehicle's location with incremental re-alignment based on recorded or estimated deviations from the initial location. In some implementations, a position can be registered directly within the map data 110.

In some implementations, the map data 110 can include a large volume of data subdivided into geographic tiles, such that a desired region of a map stored in the map data 110 can be reconstructed from one or more tiles. For instance, a plurality of tiles selected from the map data 110 can be stitched together by the sub-control system 101 based on a position obtained by the localization system 130 (e.g., a number of tiles selected in the vicinity of the position).

In some implementations, the localization system 130 can determine positions (e.g., relative or absolute) of one or more attachments or accessories for an autonomous vehicle. For instance, an autonomous vehicle can be associated with a cargo platform, and the localization system 130 can provide positions of one or more points on the cargo platform. For example, a cargo platform can include a trailer or other device towed or otherwise attached to or manipulated by an autonomous vehicle, and the localization system 130 can provide for data describing the position (e.g., absolute, relative, etc.) of the autonomous vehicle as well as the cargo platform. Such information can be obtained by the other autonomy systems to help operate the autonomous vehicle.

The sub-control system(s) 101 can include the perception system 140, which can allow an autonomous platform to detect, classify, and track objects and actors in its environment. Environmental features or objects perceived within an environment can be those within the field of view of the sensor(s) 102 or predicted to be occluded from the sensor(s) 102. This can include object(s) not in motion or not predicted to move (static objects) or object(s) in motion or predicted to be in motion (dynamic objects/actors).

The perception system 140 can determine one or more states (e.g., current or past state(s), etc.) of one or more objects that are within the surrounding environment of an autonomous vehicle. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 140 can determine the state(s) using one or more algorithms or machine-learned models configured to identify/classify objects based on inputs from the sensor(s) 102. The perception system can use different modalities of the sensor data 104 to generate a representation of the environment to be processed by the one or more algorithms or machine-learned models. In some implementations, state(s) for one or more identified or unidentified objects can be maintained and updated over time as the autonomous vehicle continues to perceive or interact with the objects (e.g., maneuver with or around, yield to, etc.). In this manner, the perception system 140 can provide an understanding about a current state of an environment (e.g., including the objects therein, etc.) informed by a record of prior states of the environment (e.g., including movement histories for the objects therein). Such information can be helpful as the autonomous vehicle plans its motion through the environment.

The sub-control system(s) 101 can include the planning system 150, which can be configured to determine how the autonomous platform is to interact with and move within its environment. The planning system 150 can determine one or more motion plans for an autonomous platform. A motion plan can include one or more trajectories (e.g., motion trajectories) that indicate a path for an autonomous vehicle to follow. A trajectory can be of a certain length or time range. The length or time range can be defined by the computational planning horizon of the planning system 150. A motion trajectory can be defined by one or more waypoints (with associated coordinates). The waypoint(s) can be future location(s) for the autonomous platform. The motion plans can be continuously generated, updated, and considered by the planning system 150.

The planning system 150 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 150 can determine a desired trajectory for executing a strategy. For instance, the planning system 150 can obtain one or more trajectories for executing one or more strategies. The planning system 150 can evaluate trajectories or strategies (e.g., with scores, costs, rewards, constraints, etc.) and rank them. For instance, the planning system 150 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 150 can utilize static cost(s) to evaluate trajectories for the autonomous platform (e.g., “avoid lane boundaries,” “minimize jerk,” etc.). Additionally, or alternatively, the planning system 150 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 150 can rank trajectories based on one or more static costs, one or more dynamic costs, or a combination thereof. The planning system 150 can select a motion plan (and a corresponding trajectory) based on a ranking of a plurality of candidate trajectories. In some implementations, the planning system 150 can select the highest ranked candidate, or a highest ranked feasible candidate.

The planning system 150 can then validate the selected trajectory against one or more constraints before the trajectory is executed by the autonomous platform.

To help with its motion planning decisions, the planning system 150 can be configured to perform a forecasting function. The planning system 150 can forecast future state(s) of the environment. This can include forecasting the future state(s) of other actors in the environment. In some implementations, the planning system 150 can forecast future state(s) based on current or past state(s) (e.g., as developed or maintained by the perception system 140). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous vehicle. Additionally, or alternatively, the probabilities can include probabilities conditioned on trajectory options available to one or more other actors.

To implement selected motion plan(s), the sub-control system(s) 101 can include a control system 160 (e.g., a vehicle control system). Generally, the control system 160 can provide an interface between the sub-control system(s) 101 and the platform control devices 112 for implementing the strategies and motion plan(s) generated by the planning system 150. For instance, the control system 160 can implement the selected motion plan/trajectory to control the autonomous platform's motion through its environment by following the selected trajectory (e.g., the waypoints included therein). The control system 160 can, for example, translate a motion plan into instructions for the appropriate platform control devices 112 (e.g., acceleration control, brake control, steering control, etc.). By way of example, the control system 160 can translate a selected motion plan into instructions to adjust a steering component (e.g., a steering angle) by a certain number of degrees, apply a certain magnitude of braking force, increase/decrease speed, etc. In some implementations, the control system 160 can communicate with the platform control devices 112 through communication channels including, for example, one or more data buses (e.g., controller area network (CAN), etc.), onboard diagnostics connectors (e.g., OBD-II, etc.), or a combination of wired or wireless communication links. The platform control devices 112 can send or obtain data, messages, signals, etc. to or from the sub-control system(s) 101 (or vice versa) through the communication channel(s).

The sub-control system(s) 101 can receive, through communication interface(s) 106, assistive signal(s) from remote assistance system 170. Remote assistance system 170 can communicate with the sub-control system(s) 101 over a network. In some implementations, the sub-control system(s) 101 can initiate a communication session with the remote assistance system 170. For example, the sub-control system(s) 101 can initiate a session based on or in response to a trigger. In some implementations, the trigger may be an alert, an error signal, a map feature, a request, a location, a traffic condition, a road condition, etc.

After initiating the session, the sub-control system(s) 101 can provide context data to the remote assistance system 170. The context data may include sensor data 104 and state data of the autonomous vehicle. For example, the context data may include a live camera feed from a camera of the autonomous vehicle and the autonomous vehicle's current speed. An operator (e.g., human operator) of the remote assistance system 170 can use the context data to select assistive signals. The assistive signal(s) can provide values or adjustments for various operational parameters or characteristics for the sub-control system(s) 101. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the sub-control system(s) 101.

The sub-control system(s) 101 can use the assistive signal(s) for input into one or more autonomy subsystems for performing autonomy functions. For instance, the planning system 150 can receive the assistive signal(s) as an input for generating a motion plan. For example, assistive signal(s) can include constraints for generating a motion plan. Additionally, or alternatively, assistive signal(s) can include cost or reward adjustments for influencing motion planning by the planning system 150. Additionally, or alternatively, assistive signal(s) can be considered by the sub-control system(s) 101 as suggestive inputs for consideration in addition to other received data (e.g., sensor inputs, etc.).

The sub-control system(s) 101 may be platform agnostic, and the control system 160 can provide control instructions to platform control devices 112 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

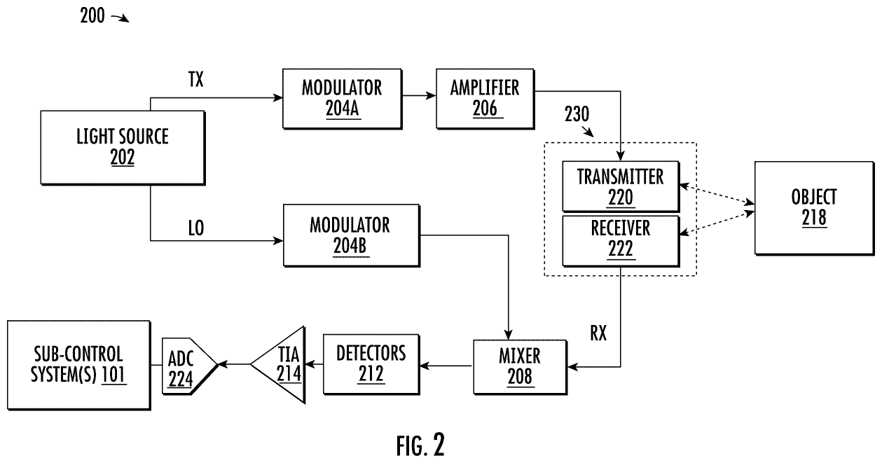

FIG. 2 is a block diagram illustrating a LIDAR system for autonomous vehicles, according to some implementations. The environment includes a LIDAR system 200 that includes a transmit (Tx) path and a receive (Rx) path. The Tx path includes one or more Tx input/output ports (e.g., channels), and the Rx path includes one or more Rx input/output ports (e.g., channels). In some implementations, a semiconductor substrate and/or semiconductor package may include the Tx path and/or the Rx path. In some implementations, the semiconductor substrate and/or semiconductor package may include at least one of silicon photonics circuitry, programmable logic controller (PLC), or group III-V semiconductor circuitry.

In some implementations, a first semiconductor substrate and/or a first semiconductor package may include the Tx path and a second semiconductor substrate and/or a second semiconductor package may include the Rx path. In some arrangements, the Rx input/output ports and/or the Tx input/output ports may occur (or be formed/disposed/located/placed) along one or more edges of one or more semiconductor substrates and/or semiconductor packages.

The LIDAR system 200 can be coupled to one or more sub-control system(s) 101 (e.g., the sub-control system(s) 101 of FIG. 1). In some implementations, the sub-control system(s) 101 may be coupled to the Rx path via the one or more Rx input/output ports. For instance, the sub-control system(s) 101 can receive LIDAR outputs from the LIDAR system 200. The sub-control system(s) 101 can control a vehicle (e.g., an autonomous vehicle) based on the LIDAR outputs.

The Tx path may include a light source (e.g., laser source) 202, a modulator 204A, a modulator 204B, an amplifier 206, and one or more transmitters 220. The Rx path may include one or more receivers 222, a mixer 208, a detector 212, a transimpedance amplifier (TIA) 214, and one or more analog-to-digital converters (ADCs) 224. Although FIG. 2 shows only a select number of components and only one input/output channel, the LIDAR system 200 may include any number of components and/or input/output channels (in any combination) that are interconnected in any arrangement to facilitate combining multiple functions of a LIDAR system, to support the operation of a vehicle.

The light source 202 may be configured to generate a light signal (or beam) that is derived from (or associated with) a local oscillator (LO) signal. In some implementations, the light signal may have an operating wavelength that is equal to or substantially equal to 1550 nanometers. In some implementations, the light signal may have an operating wavelength that is between 1400 nanometers and 1440 nanometers.

The light source 202 may be configured to provide the light signal to the modulator 204A, which is configured to modulate a phase and/or a frequency of the light signal based on a first radio frequency (RF) signal (e.g., an “RF1” signal) to generate a modulated light signal, such as by Continuous Wave (CW) modulation or quasi-CW modulation. The modulator 204A may be configured to send the modulated light signal to the amplifier 206. The amplifier 206 may be configured to amplify the modulated light signal to generate an amplified light signal for transmission via the one or more transmitters 220. The one or more transmitters 220 may include one or more optical waveguides or antennas. In some implementations, modulator 204A and/or modulator 204B may have a bandwidth between 400 megahertz (MHz) and 1000 (MHz).

The LIDAR system 200 includes one or more transmitters 220 and one or more receivers 222. The transmitter(s) 220 and/or receiver(s) 222 can be included in a transceiver 230. The transmitter(s) 220 can provide the transmit beam that it receives from the Tx path into an environment within a given field of view toward an object 218. The one or more receivers 222 can receive a received beam reflected from the object 218 and provide the received beam to the mixer 208 of the Rx path. The one or more receivers 222 may include one or more optical waveguides or antennas. In some arrangements, the one or more transceivers 230 may include a monostatic transceiver or a bistatic transceiver.

The light source 202 may be configured to provide the LO signal to the modulator 204B, which is configured to modulate a phase and/or a frequency of the LO signal based on a second RF signal (e.g., an “RF2” signal) to generate a modulated LO signal (e.g., using Continuous Wave (CW) modulation or quasi-CW modulation) and send the modulated LO signal to the mixer 208 of the Rx path. The mixer 208 may be configured to mix (e.g., combine, multiply, etc.) the modulated LO signal with the returned signal to generate a down-converted signal and send the down-converted signal to the detector 212.

In some arrangements, the mixer 208 may be configured to send the modulated LO signal to the detector 212. The detector 212 may be configured to generate an electrical signal based on the down-converted signal and send the electrical signal to the TIA 214. In some arrangements, the detector 212 may be configured to generate an electrical signal based on the down-converted signal and the modulated signal. The TIA 214 may be configured to amplify the electrical signal and send the amplified electrical signal to the sub-control system(s) 101 via the one or more ADCs 224. In some implementations, the TIA 214 may have a peak noise-equivalent power (NEP) that is less than 5 picowatts per square root Hertz (i.e., 5×10-12 Watts per square root Hertz). In some implementations, the TIA 214 may have a gain between 4 kiloohms and 25 kiloohms. In some implementations, detector 212 and/or TIA 214 may have a 3-decibel bandwidth between 80 kilohertz (kHz) and 450 megahertz (MHz).

The sub-control system(s) 101 may be configured to determine a distance to the object 218 and/or measure the velocity of the object 218 based on the one or more electrical signals that it receives from the TIA 214 via the one or more ADCs 224.

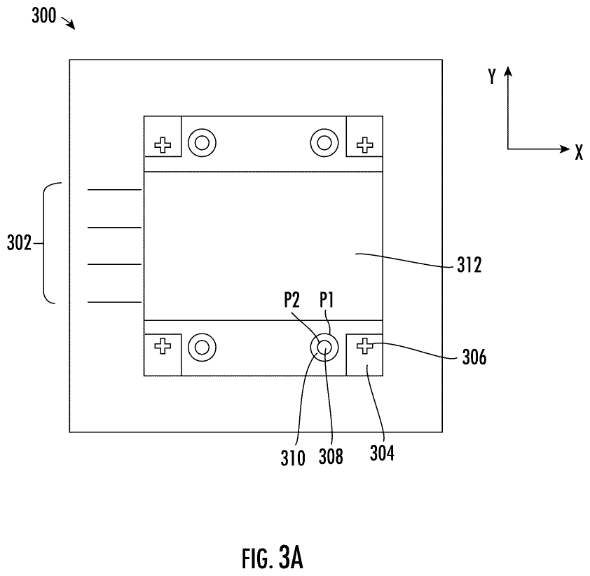

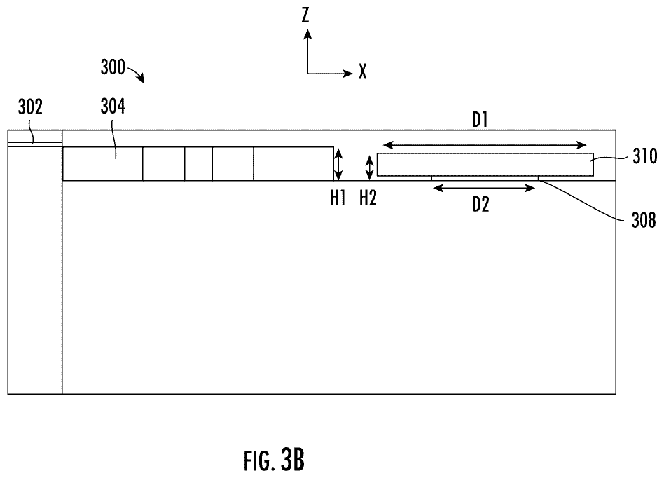

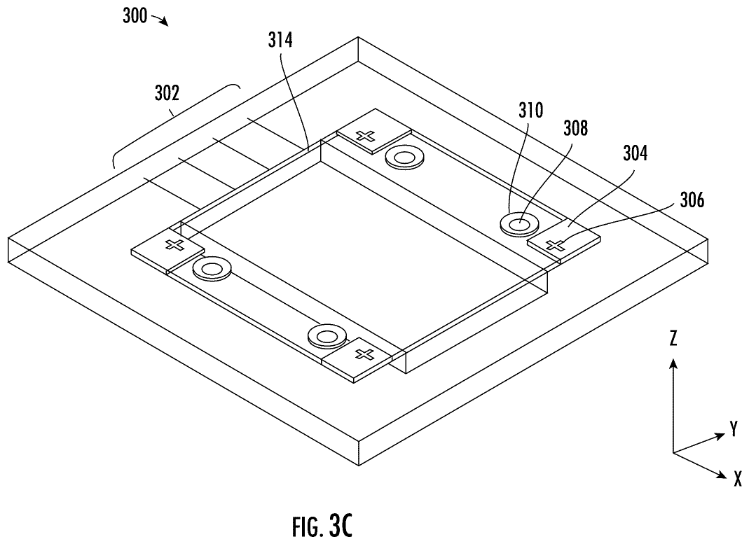

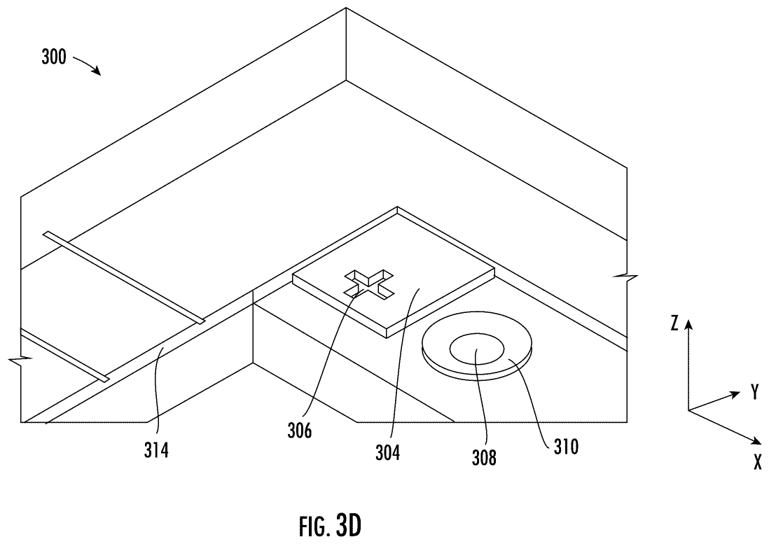

FIGS. 3A-3D depict a first optical component 300 which can be coupled to one or more other optical components in an optical system for a LIDAR system according to some implementations of the disclosure. The first optical component 300 can be included in a LIDAR system, such as the LIDAR system 200 of FIG. 2 and the like.

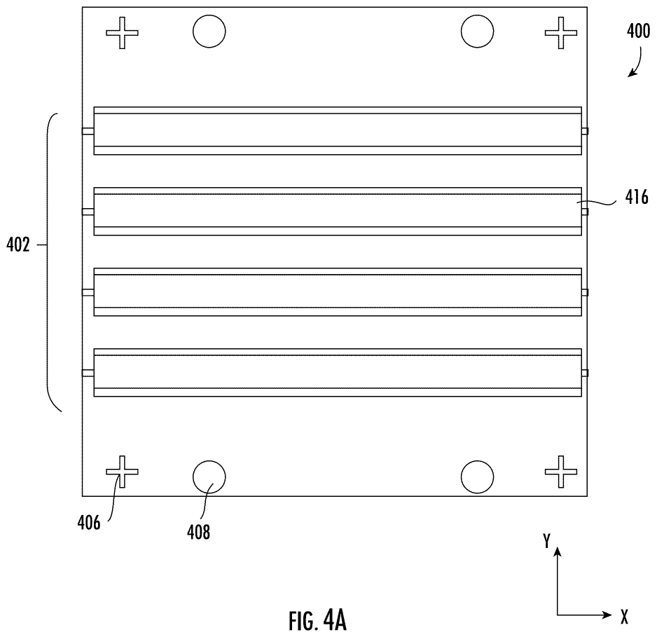

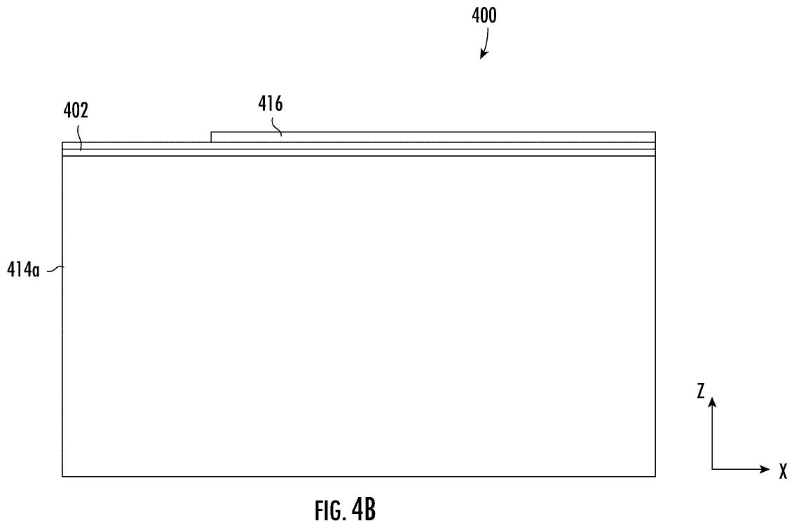

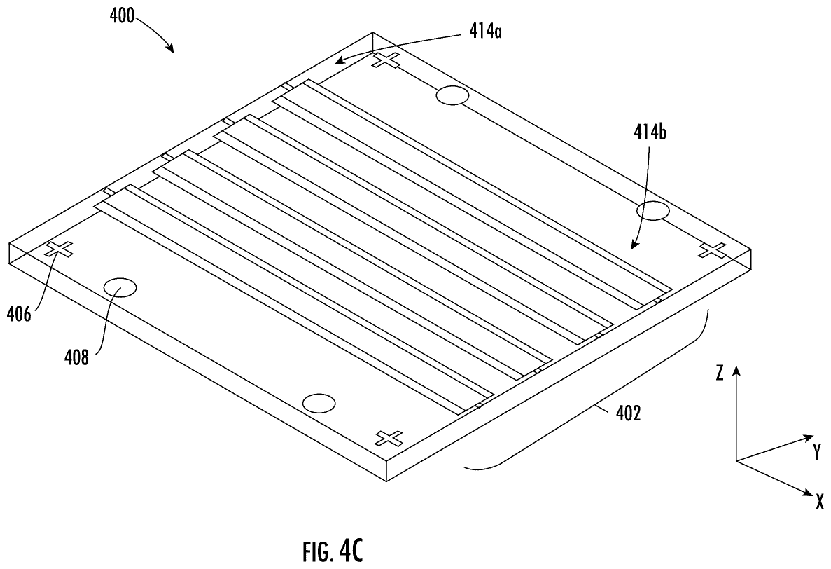

The first optical component 300 may correspond to a silicon chip, for example a silicon photonics integrated circuit (Si PIC) chip. Referring to the top view of the first optical component 300 in FIG. 3A and the perspective views of FIGS. 3C-3D, the first optical component 300 may include a plurality of waveguides 302 and an optical facet 314 where light can be either coupled in or out of the plurality of waveguides 302. The first optical component 300 may include two waveguides, three waveguides, four waveguides, etc. The first optical component 300 may include one or more mechanical stops (e.g., pedestals) 304. The one or more mechanical stops 304 can be utilized for out-of-plane alignment with a second optical component 400 (see FIGS. 4A-4C). Out-of-plane alignment can refer to the alignment of components in the Z direction or vertical direction which is perpendicular to the X-Y plane (e.g., alignment of the first optical component 300 with the second optical component 400 in the Z direction). In some implementations, the one or more mechanical stops 304 may each include a fiducial mark 306 which may be etched in a surface of the first optical component 300. Each fiducial mark 306 may be utilized for in-plane alignment with the second optical component 400. In-plane alignment can refer to the alignment of components in the X-Y plane or a lateral direction (e.g., alignment of the first optical component 300 with respect to the second optical component 400 in the X-Y plane). In the example embodiment of FIGS. 3A-3D, the first optical component 300 includes four mechanical stops 304 each having a fiducial mark 306. Although FIGS. 3A-3D illustrate square-shaped mechanical stops 304 and cross-shaped fiducial marks 306, mechanical stops 304 and/or fiducial marks 306 may have alternative shapes in accordance with other embodiments of the disclosed technology.

The first optical component 300 may include one or more under bump metal pads 308 onto which solder 310 is deposited or applied. In the example embodiment of FIGS. 3A-3D, the first optical component 300 includes four under bump metal pads 308 each having solder 310 deposited thereon. For example, each of the under bump metal pads 308 may be disposed adjacent to a corresponding mechanical stop among the one or more mechanical stops 304. The first optical component 300 may also include a through-hole 312.

FIG. 3B shows a side view of a portion of the first optical component 300. As illustrated in FIG. 3B, the first optical component 300 has solder 310 which is pre-deposited on one of the under bump metal pads 308 on a surface of dielectric material (e.g., silicon dioxide). The pre-deposited solder 310 is provided such that the footprint (e.g., area) of the solder 310 is greater than the under bump metal pad 308 (before heating or melting of the solder 310). For example, the area or perimeter p1 of the solder 310 (e.g., a circumference of the solder 310 as denoted in FIG. 3A) may be greater than the area or perimeter p2 of the under bump metal pad 308 (e.g., a circumference of the under bump metal pad 308 as denoted in FIG. 3A). For example, the width or diameter D1 of the solder 310 may be greater than the width or diameter D2 of the under bump metal pad 308 (e.g., in the x-direction shown in FIG. 3B). As illustrated in FIG. 3B, the height h1 of the mechanical stop 304 is greater than the height h2 of the pre-deposited solder 310 (before heating or melting of the solder 310). The height h1 and height h2 are defined in the z-direction as shown in FIG. 3B. For example, the height h1 of the mechanical stop 304 is greater than the combined height of the under bump metal pad 308 and the pre-deposited solder 310 (before heating or melting of the solder 310). While the shape of the solder 310 and the under bump metal pad 308 are shown as being circular-shaped in FIGS. 3A-3C, this is only an example and the solder 310 and the under bump metal pad 308 may be differently shaped. As described herein, when the second optical component 400 is coupled to the first optical component 300, the solder 310 is not in contact with the second optical component 400 in the z-direction. In other words, the solder 310 is spaced apart from the second optical component while the one or more mechanical stops 304 are configured to support the second optical component 400. For example, the solder 310 does not come into contact with the second optical component 400 when the first optical component 300 and the second optical component 400 are coupled or pressed together at the end of an alignment operation (e.g., using a flip chip bonding machine or system).

As shown in FIGS. 3A-3C, the first optical component 300 can include the through-hole 312 which may be disposed in a central portion of the first optical component 300. A first recess may be disposed on a first side of the through-hole 312 (e.g., bordering the through-hole 312), and a second recess may be disposed on a second side of the through-hole 312 (e.g., bordering an opposite side of the through-hole 312). In an example embodiment, a first plurality of mechanical stops 304 may be disposed in the first recess (e.g., in opposite corners of the first recess) and a second plurality of mechanical stops 304 may be disposed in the second recess (e.g., in opposite corners of the second recess). In an example embodiment, a first plurality of under bump metal pads 308 onto which solder 310 (e.g., first solder) is deposited may be disposed in the first recess (e.g., adjacent to a corresponding mechanical stop among the first plurality of mechanical stops 304) and a second plurality of under bump metal pads 308 onto which solder 310 (e.g., second solder) is deposited may be disposed in the second recess (e.g., adjacent to a corresponding mechanical stop among the second plurality of mechanical stops 304). In some implementations, the plurality of waveguides 302 may be disposed at a third side of the through-hole 312.

FIGS. 4A-4C depict a second optical component 400 which can be coupled to one or more other optical components in an optical system for a LIDAR system according to some implementations of the disclosure. The second optical component 400 can be included in a LIDAR system, such as the LIDAR system 200 of FIG. 2 and the like.

For example, the second optical component 400 may correspond to a fiber array unit or a laser diode (LD) chip. Referring to the top view of the second optical component 400 in FIG. 4A and perspective view of FIG. 4C, the second optical component 400 may include a plurality of emitters 402 and optical facets 414a, 414b where light (e.g., a laser beam) can be emitted from the plurality of emitters 402. The second optical component 400 may include two emitters, three emitters, four emitters (e.g., 4-channel emitters), etc. The second optical component 400 may include one or more fiducial marks 406 (second portions) which can be utilized for in-plane alignment with the first optical component 300. The one or more fiducial marks 406 may be etched in a surface of the second optical component 400 and may substantially mirror the one or more fiducial marks 306 of first optical component 300. In the example embodiment of FIGS. 4A-4C, the second optical component 400 includes four fiducial marks. The second optical component 400 may include one or more under bump metal pads 408 (first portions) for solder bonding with the solder 310 which is deposited (applied) to the first optical component 300. In the example embodiment of FIGS. 4A-4C, the second optical component 400 includes four under bump metal pads 408. For example, each of the under bump metal pads 408 may be disposed adjacent to a corresponding fiducial mark among the one or more fiducial marks 406.

FIG. 4B shows a side view of a portion of the second optical component 400. FIG. 4B depicts an emitter from among a plurality of emitters 402 and optical facet 414a where light (e.g., a laser beam) can be emitted from the emitter. FIG. 4B further depicts a heat spreader 416 which is disposed on a side of the second optical component 400 including the plurality of emitters 402. For example, the heat spreader 416 may be formed by a plated metal film, such as a film including gold, a gold alloy, and/or other suitable conductive metal.

As described herein, when the second optical component 400 is coupled to the first optical component 300, the solder 310 is not in contact with or spaced apart from the under bump metal pads 408 of the second optical component 400 in the z-direction while the one or more mechanical stops 304 may be configured to support the second optical component 400 (e.g., second portions of the second optical component 408 corresponding to locations of the one or more fiducial marks 406). In some implementations, the second optical component 400 can partially or entirely cover the through-hole 312. The second optical component 400 can be disposed at least partially within the recessed area (the first recess and the second recess), which can provide a compact configuration. For example, the solder 310 does not come into contact with the under bump metal pads 408 of the second optical component 400 when the first optical component 300 and the second optical component 400 are coupled or pressed together at the end of an alignment operation (e.g., using a flip chip bonding machine or system).

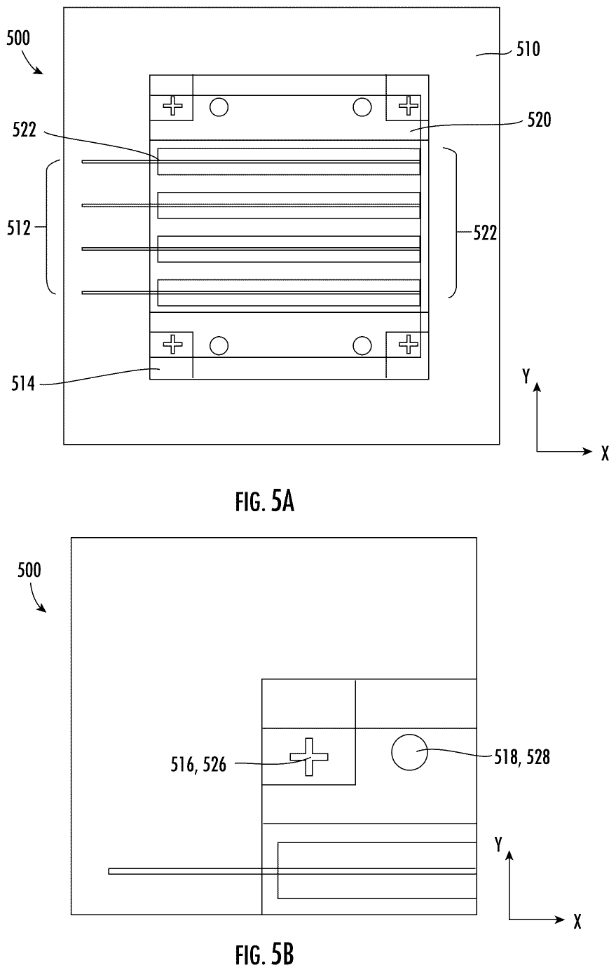

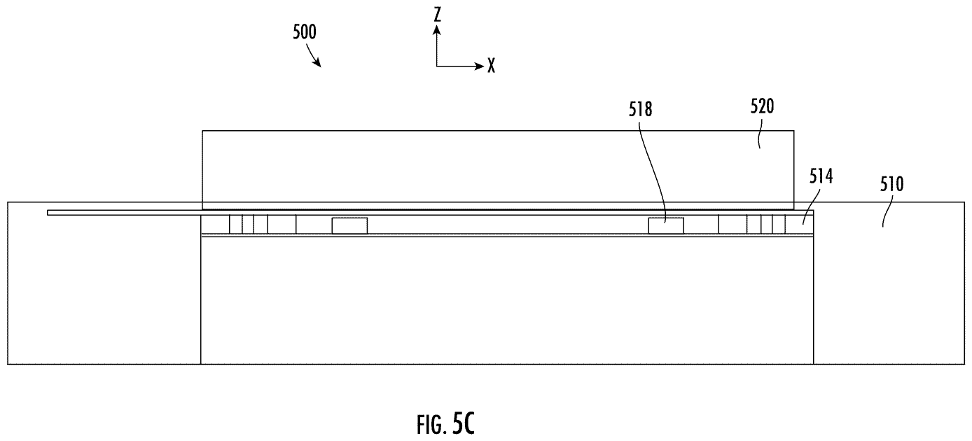

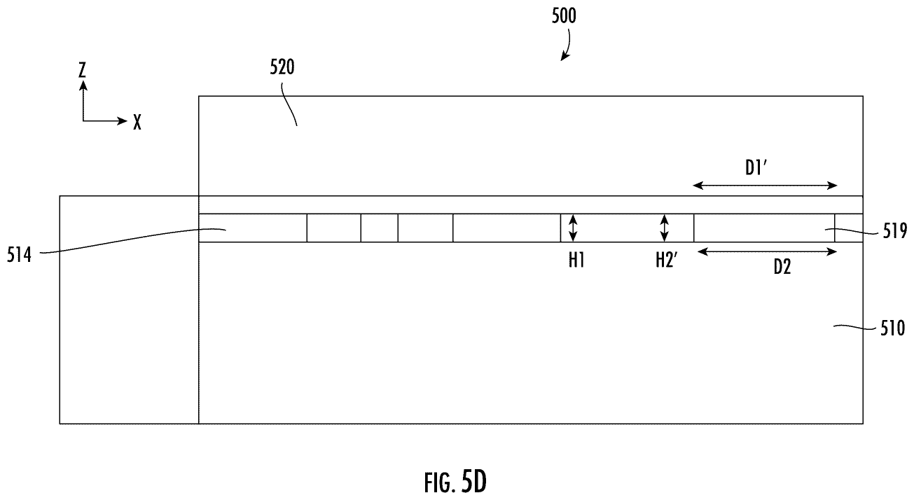

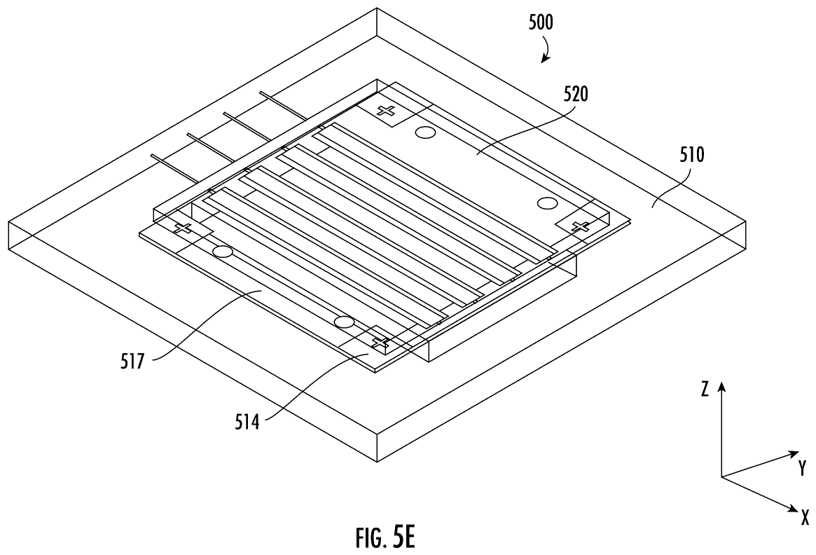

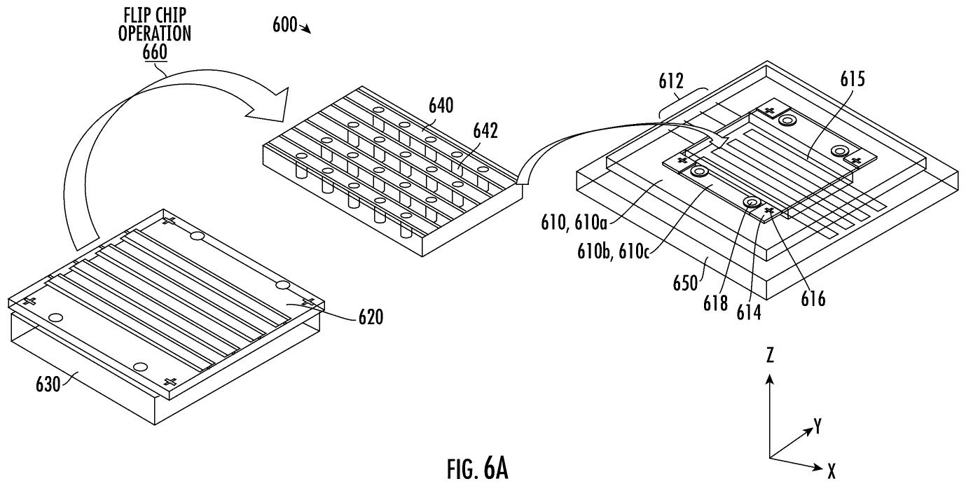

FIGS. 5A-5E depict an optical system having a first optical component coupled to a second optical component for a LIDAR system, according to some implementations of the disclosure. The optical system can be included in a LIDAR system, such as the LIDAR system 200 of FIG. 2 and the like.

Referring to the top views of FIGS. 5A-5B and the perspective view of FIG. 5E, an optical system 500 includes a first optical component 510 which is coupled to a second optical component 520. The first optical component 510 includes a plurality of waveguides 512, a plurality of mechanical stops 514, a plurality of fiducial marks 516, and a plurality of under bump metal pads 518. For example, the first optical component 510 can correspond to the first optical component 300 of FIGS. 3A-3D and therefore a detailed description of the features of the first optical component 510 will not be repeated for the sake of brevity. The second optical component 520 includes a plurality of emitters 522, a plurality of fiducial marks 526, and a plurality of under bump metal pads 528. For example, the second optical component 520 can correspond to the second optical component 400 of FIGS. 4A-4C and therefore a detailed description of the features of the second optical component 520 will not be repeated for the sake of brevity. As depicted in FIG. 5A, each waveguide of the plurality of waveguides 512 of the first optical component 510 is aligned (for out-of-plane alignment) with a corresponding emitter of the plurality of emitters 522 of the second optical component 520.

Referring to FIG. 5B, a portion of the optical system 500 is depicted which shows a fiducial mark 516 of the first optical component 510 aligned (for in-plane alignment) with a fiducial mark 526 of the second optical component 520. Further, an under bump metal pad 518 of the first optical component 510 having solder deposited thereon is bonded to an under bump metal pad 528 of the second optical component 520 via the solder 519.

According to examples of the disclosure, a flip chip bonding operation (flip chip operation) may be implemented (e.g., via flip-chip machinery or mechanisms including flip-chip bonders, grippers, etc.) to align the first optical component 510 and the second optical component 520. For example, the fiducial marks 516, 526 on the mating surfaces of the first optical component 510 and the second optical component 520 can be aligned to achieve submicron in-plane alignment accuracy. For example, the flip chip bonding machine may be implemented to hold the second optical component 520 with significant force in a direction toward the first optical component 510 (e.g., in the z-direction) during the bonding process to prevent relative lateral and vertical shifts of the first optical component 510 and the second optical component 520. The positioning of the second optical component 520 may be determined by the one or more mechanical stops 514 built into the first optical component 510 (e.g., in a recessed portion 517 of the first optical component 510), and a bonding material, such as the solder 519. For example, when the solder 519 is melted, the solder 519 can be induced to fill in a metal trace pre-defined on a surface of the second optical component 520, while the first optical component 510 and the second optical component 520 are held together as one rigid body. Thus, the first optical component 510 and the second optical component 520 are bonded by melting the pre-deposited solder (e.g., the solder 310 as shown in FIG. 3B), causing the solder 519 to spread on the metal trace with which it is in contact, and to move into the gap between the first optical component 510 and the second optical component 520 via capillary force.

Referring to FIGS. 5C-5D, a side view of the optical system 500 is depicted which shows how, after heating (e.g., melting) of the solder 519, the diameter D1′ of the solder 519 has decreased and the height h2′ of the solder 519 has increased. For example, the solder 519 footprint (e.g., perimeter or area) can shrink to fit the size and/or shape of the under bump metal pad 518 during reflowing, increasing the solder 519 height to allow contact with the under bump metal pad 528 of the second optical component 520. For example, the height h2′ of the solder 519 can increase so that the height h2′ of the solder 519 is equal or substantially equal to the height h1 of the mechanical stop 514. For example, the perimeter or area of the solder 519 can decrease so that the perimeter or area of the solder 519 is equal or substantially equal to the perimeter or area of the under bump metal pad 518 of the first optical component 510. The solder 519 can be induced to shrink its footprint (e.g., due to surface energy minimization principles) and to grow its height upon melting, by manipulating different wetting properties with metal and dielectric materials, thus leading to contact with the second optical component 520 to form the bond.

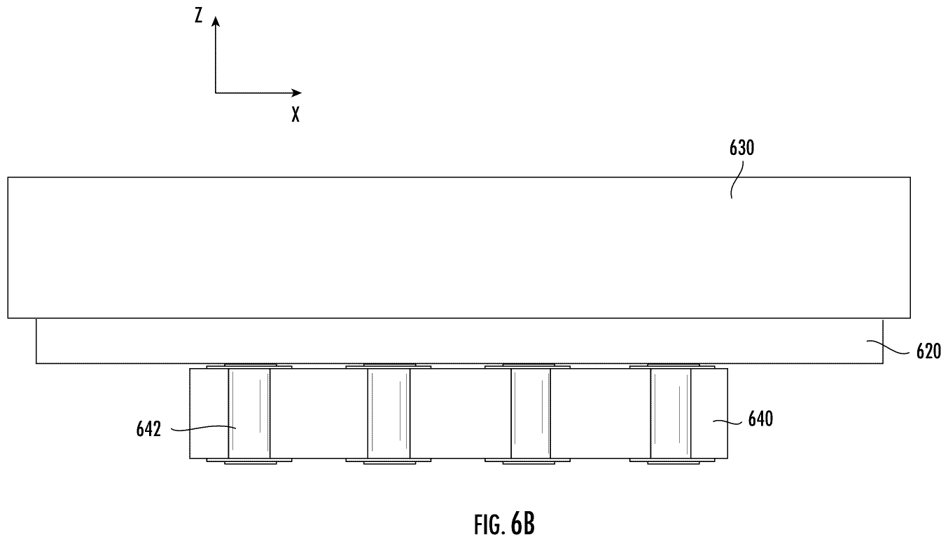

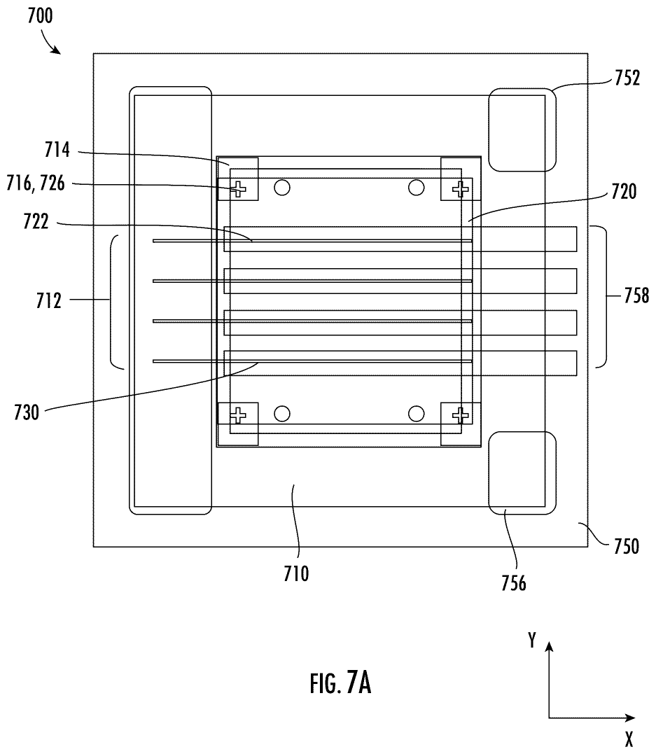

FIG. 6A depicts process operations 600 for bonding heat spreaders to the second optical component 400 which can be coupled to one or more other optical components in an optical system for a LIDAR system according to some implementations of the disclosure. The second optical component 400 coupled to the heat spreaders can be included in a LIDAR system, such as the LIDAR system 200 of FIG. 2 and the like.

Referring to FIG. 6A, a first operation of the process operations 600 includes coupling a first heat spreader 630 (e.g., a submount optical component or a submount optical chip) to a first side of a second optical component 620. The second optical component 620 can correspond to the second optical component 400 of FIGS. 4A-4C and therefore a detailed description of the features of the second optical component 620 will not be repeated for the sake of brevity. In some implementations, the first heat spreader 630 may be coupled to the second optical component 620 via a bonding material (e.g., epoxy, glue, etc.).

A second operation of the process operations 600 includes implementing a flip chip operation 660 to flip over the second optical component 400 having the first heat spreader 630 coupled thereto, and coupling a second heat spreader 640 (e.g., a submount optical component or a submount optical chip) to a second side of the second optical component 620. In some implementations, the second heat spreader 640 may be coupled to the second optical component 620 via a bonding material (e.g., epoxy, glue, etc.). In some implementations, the first heat spreader 630 and/or the second heat spreader 640 can be thermally conductive. For example, as depicted in FIGS. 6A and 6B, the first heat spreader 630 and/or the second heat spreader 640 can include a plurality of through-chip vias 642 which may be filled with metal for electrical and/or thermal conductivity.

A third operation of the process operations 600 includes inserting the second optical component 400 having the first heat spreader 630 and the second heat spreader 640 coupled thereto, into the through-hole 615 of the first optical component 610, which can provide a compact configuration. The first optical component 610 includes a plurality of waveguides 612, a plurality of mechanical stops 614, a plurality of fiducial marks 616, and a plurality of under bump metal pads 618 onto which solder can be pre-deposited. For example, the first optical component 610 can correspond to the first optical component 300 of FIGS. 3A-3D and therefore a detailed description of the features of the first optical component 510 will not be repeated for the sake of brevity. In some implementations, the second heat spreader 640 may be disposed entirely or partially below an outer (out-of-plane) surface 610a of the first optical component 610. In some implementations, the second heat spreader 640 may be disposed entirely or partially below an inner (in-plane) surface 610b of a recessed portion 610c of the first optical component 610.

As depicted in FIG. 6A, in some implementations, the first optical component 610 can also be coupled to a carrier 650 (heat sink). In some implementations, the second heat spreader 640 may be coupled to the carrier 650 (e.g., electrically and/or thermally) via the through-hole 615, where the carrier 650 serves as both a heat sink and an electrical terminal for the optical system. In some implementations, the carrier 650 may be coupled to the first optical component 610 and/or the second heat spreader 640 via a bonding material (e.g., epoxy, glue, etc.).

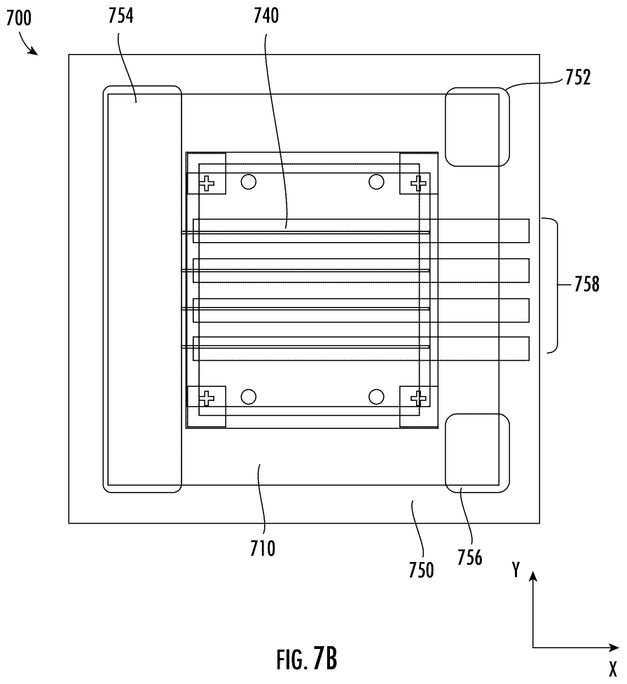

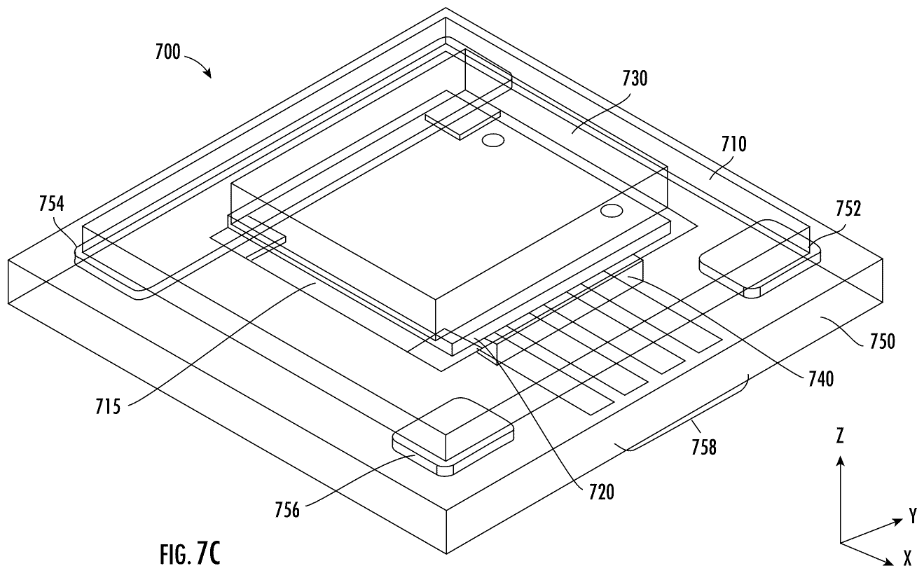

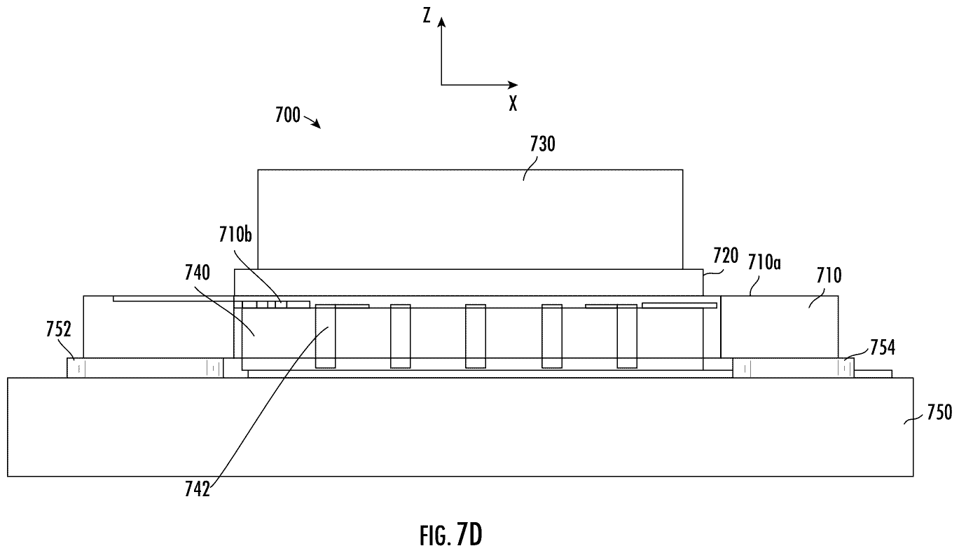

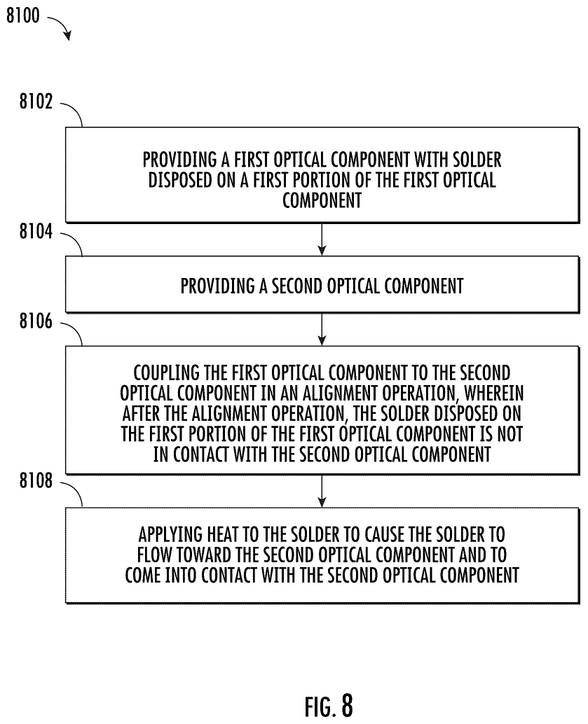

FIGS. 7A-7D depict an optical system having a plurality of optical components, according to some implementations of the disclosure. The optical system can be included in a LIDAR system, such as the LIDAR system 200 of FIG. 2 and the like.

Referring to the top view of FIG. 7A and perspective view of FIG. 7C, an optical system 700 includes a first optical component 710 which is coupled to a second optical component 720. The first optical component 710 includes a plurality of waveguides 712, a plurality of mechanical stops 714, a plurality of fiducial marks 716, and a plurality of under bump metal pads each having solder deposited thereon (not shown) which bonds the first optical component 710 to the second optical component 720. For example, the first optical component 710 can correspond to the first optical component 300 of FIGS. 3A-3D and therefore a detailed description of the features of the first optical component 710 will not be repeated for the sake of brevity. The second optical component 720 includes a plurality of emitters 722, a plurality of fiducial marks 726, and a plurality of under bump metal pads (not shown) to which the solder deposited on the plurality of under bump metal pads of the first optical component 710 is bonded. For example, the second optical component 720 can correspond to the second optical component 400 of FIGS. 4A-4C and therefore a detailed description of the features of the second optical component 720 will not be repeated for the sake of brevity. As depicted in FIG. 7A, each waveguide of the plurality of waveguides 712 of the first optical component 710 is aligned (for out-of-plane alignment) with a corresponding emitter of the plurality of emitters 722 of the second optical component 720.

As further illustrated in FIGS. 7A and 7C and the side view of FIG. 7D, a first heat spreader 730 is coupled to a first side of the second optical component 720 and a second heat spreader 740 is coupled to a second side of the second optical component 720. In some implementations, the second optical component 720 can correspond to a laser diode chip and the first side of the second optical component 720 can correspond to a N-side of the laser diode chip, and the first heat spreader 730 can be coupled to the N-side of the second optical component 720. The N-side of the laser diode chip may include elements (e.g., dopants) that add extra electrons (negatively charged carriers) to the material. In some implementations, the N-side of the laser diode chip can include a metal contact. In some implementations, the second optical component 720 can correspond to a laser diode chip and the second side of the second optical component 720 can correspond to a P-side of the laser diode chip, and the second heat spreader 740 can be coupled to the P-side of the second optical component 720. The P-side of the laser diode chip may include elements (e.g., dopants) that create holes (positively charged carriers) in the material. The first optical component 710 (e.g., a Si PIC chip) can include a through-hole 715 in which at least the second heat spreader 740 and optionally the second optical component 720 can be inserted. In some implementations, the second heat spreader 740 may be disposed entirely or partially below an outer (out-of-plane) surface 710a of the first optical component 610. In some implementations, the second heat spreader 740 may be disposed entirely or partially below an inner (in-plane) surface 710b of a recessed portion of the first optical component 710. In some implementations, a portion of the second heat spreader 740 may protrude out of the first optical component 710.

As illustrated in FIGS. 7A-7D, a carrier 750 (heat sink) can be coupled to the first optical component 710 and the second optical component 720 (e.g., via the second heat spreader 740). For example, the carrier 750 can be coupled to the first optical component 710 and/or the second optical component 720 via a bonding material (e.g., glue, epoxy, etc.). For example, as shown in FIGS. 7A-7D, the carrier 750 can be coupled to the first optical component 710 via glue 752, 754, 756 at a plurality of different locations. The carrier 750 can further include one or more conductor traces 758 that can be connected via the through-hole 715 to the second side of the second optical component 720 for supplying power. In some implementations, the second optical component 720 can correspond to a laser diode chip and the one or more conductor traces 758 can be connected to the P-side of the laser diode chip for supplying power. For example, as depicted in FIG. 7D the second heat spreader 740 can include a plurality of through-chip vias 742 (conductor-filled via holes) which may be filled with metal for electrical and/or thermal conductivity. The plurality of through-chip vias 742 can provide an electrical and/or a thermal path from the second optical component 720 to the carrier 750 to aid in heat dissipation.

Referring to FIG. 7B, a bottom view of the optical system 700 is depicted which shows the second heat spreader 740 coupled to the second optical component 720 and the carrier 750 coupled to the first optical component 710. The first optical component 710 can include a bonding material (e.g., glue, epoxy, etc.). For example, as shown in FIG. 7B, the first optical component 710 can include glue 752, 754, 756 at a plurality of different locations to couple the first optical component 710 to the carrier 750. As shown in FIG. 7B, the second heat spreader 740 is coupled to the second side of the second optical component 720 (e.g., a P-side of a laser diode chip).

Described herein are methods for manufacturing a semiconductor-based LIDAR system for a vehicle, which can ensure that specification requirements are satisfied. As described in more detail herein, the method may be implemented to securely couple a plurality of optical components for an optical system provided.

FIG. 8 is a flow diagram of a method 8100 for manufacturing a semiconductor-based LIDAR system for a vehicle, according to some implementations of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 8, at operation 8102, the method 8100 includes providing a first optical component with solder disposed on a first portion of the first optical component. For example, the first optical component may correspond to a silicon chip, for example a silicon chip with a multi-channel waveguide (e.g., a three-channel waveguide, a four-channel waveguide, etc.) or other types of semiconductor optical devices (e.g., a silicon photonics integrated circuit, a silicon photonics integrated circuit having a through-hole, etc.). For example, the first optical component can correspond to any of the first optical components 300, 510, 610, 710.

In some implementations, the first portion can correspond to an under bump metal pad (e.g., under bump metal pad 308, 518, 618). In some implementations, the first portion can be located or disposed in a recess in a surface of the first optical component. For example, the first portion can be located or disposed below an inner (in-plane) surface 610b of a recessed portion 610c of the first optical component 610 as shown in FIG. 6A.

At operation 8104, the method 8100 includes providing a second optical component. For example, the second optical component may correspond to a fiber array unit, a laser diode (LD) chip, a LD array chip, etc. For example, the second optical component can correspond to any of the second optical components 400, 520, 620, 720.

At operation 8106, the method 8100 includes coupling the first optical component to the second optical component in an alignment operation, wherein after the alignment operation, the solder disposed on the first portion of the first optical component is not in contact with (e.g., is spaced apart from) the second optical component. For example, the alignment operation can include implementing a flip chip operation to couple the first optical component to the second optical component, wherein after the first optical component is coupled to the second optical component, the solder disposed on the first portion of the first optical component is not in contact with (e.g., is spaced apart from) the second optical component.

In some implementations, the alignment operation comprises aligning the first optical component with the second optical component using a first plurality of mechanical stops disposed on the first optical component and a first plurality of fiducial marks disposed on the second optical component. For example, as depicted in FIGS. 5A-5D, the first optical component 510 can be aligned with the second optical component 520 using one or more mechanical stops 514 (e.g., a first plurality of mechanical stops) disposed on the first optical component 510 and a first plurality of fiducial marks 526 disposed on the second optical component 520. For example, one or more of the mechanical stops 514 (e.g., a first plurality of mechanical stops) can be disposed adjacent to the first portion (e.g., adjacent to the under bump metal pads 518). For example, the height h1 of a mechanical stop 304 can be greater than the height h2 of the solder 310 before heat is applied to the solder 310, and the height h1 of the mechanical stop 304 can be the same or substantially the same as the height h2′ of the solder 519 after the heat is applied to the solder 519.

At operation 8108, the method 8100 includes applying heat to the solder to cause the solder to flow toward the second optical component and to come into contact with the second optical component. For example, applying heat to the solder can cause the solder to expand in a direction toward the second optical component. For example, heat can be applied to the solder deposited on the first optical component by locally or globally heating the first optical component. For example, to locally heat the first optical component 300, heat is applied or directed to solder deposited on one or more under bump metal pads. In some implementations, separate heaters (e.g., resistive heaters) may be provided or positioned at or near each location of the under bump metal pads 308 having solder 310 deposited thereon. Each of the heaters may be powered so as to heat the solder 310 deposited on the under bump metal pads 308 at the same time, or each of the heaters may be powered so as to heat the solder 310 deposited on the under bump metal pads 308 in a sequential manner. For example, to locally heat the first optical component 300, in some implementations a light source (e.g., a laser having a particular wavelength) may be provided or positioned at or near a location of an under bump metal pad 308 having solder 310 deposited thereon and the light source may be implemented (activated) to heat the solder. In some implementations, a plurality of light sources may be provided to heat solder deposited on a plurality of under bump metal pads (e.g., at the same time or in a sequential manner). For example, to globally heat the first optical component 300, heat can be applied or directed to the entire first optical component 300 such that the entire first optical component 300 is heated. For example, a heater can be provided or positioned below the first optical component 300 (at a side of the first optical component 300 which is opposite to a side of the first optical component 300 which faces the second optical component 400). For example, a heater can be provided or positioned above the first optical component 300 (at a side of the first optical component 300 which faces the second optical component 400). For example, heaters can be provided or positioned above and below the first optical component 300 (at a side of the first optical component 300 which faces the second optical component 400 and at a side of the first optical component 300 which is opposite to the side which faces the second optical component 400).

In some implementations, prior to heating the solder at operation 8108, an area of the under bump metal pad is smaller than an area of the solder before the heat is applied to the solder. In some implementations, prior to heating the solder at operation 8108, an area or perimeter of the under bump metal pad is smaller than an area or perimeter of the solder before the heat is applied to the solder. For example, as shown in FIG. 3A, the perimeter p2 of the under bump metal pad 308 is less than a perimeter p1 of the solder 310. For example, the perimeter p1 may correspond to a circumference of the solder 310 when the solder 310 has a circular or substantially circular footprint. For example, as shown in FIG. 3A, the perimeter p2 of the under bump metal pad 308 is less than the perimeter p1 of the solder 310. For example, the diameter of the solder 310 may be more than the diameter of the under bump metal pad 308.

In some implementations, applying the heat to the solder causes the solder to spread on a metal trace disposed on a surface of the second optical component, and to move into a gap between the first optical component and the second optical component via a capillary force. For example, when heat is applied to the solder after the first optical component is coupled to the second optical component in an alignment operation, the heat can cause the solder to melt and to spread on a metal trace disposed on a surface of the second optical component, and to move into a gap between the first optical component and the second optical component via a capillary force.

In some implementations, after heating the solder at operation 8108, an area of the under bump metal pad may be equal or substantially equal to an area of the solder after the heat is applied to the solder. In some implementations, after heating the solder at operation 8108, an area or perimeter of the under bump metal pad may be equal or substantially equal to an area or perimeter of the solder after the heat is applied to the solder. For example, the perimeter may correspond to a circumference of the solder 519 when the solder 519 has a circular or substantially circular footprint. For example, the diameter of the solder 519 may be equal or substantially equal to the diameter of the under bump metal pad 518. For example, as shown in FIG. 5D, the diameter D2 of the under bump metal pad 508 may be equal or substantially equal to the diameter D1′ of the solder 519.

In some implementations, the method 8100 can include coupling a first heat spreader to a first side of the laser diode array chip. For example, as depicted in FIGS. 6A-6B, first heat spreader 630 can be coupled to a first side of the second optical component 620 (e.g., a laser diode array chip). In some implementations, the alignment operation can include a flip chip operation 660 (e.g., using flip-chip machinery or mechanisms including flip-chip bonders, grippers, etc.) and flipping the laser diode array chip having the first heat spreader 630 coupled thereto over, and coupling a second heat spreader 640 to a second side of the laser diode array chip, and coupling the first optical component 610 (e.g., a silicon photonics integrated circuit chip) to the laser diode array chip by inserting the laser diode array chip having the first heat spreader 630 and the second heat spreader 640 coupled thereto, in the through-hole 615. For example, as shown in FIG. 6B, a surface area of a side of the first heat spreader 630 facing the first side of the laser diode array chip (second optical component 620) is greater than a surface area of a side of the second heat spreader 640 facing the second side of the laser diode array chip.

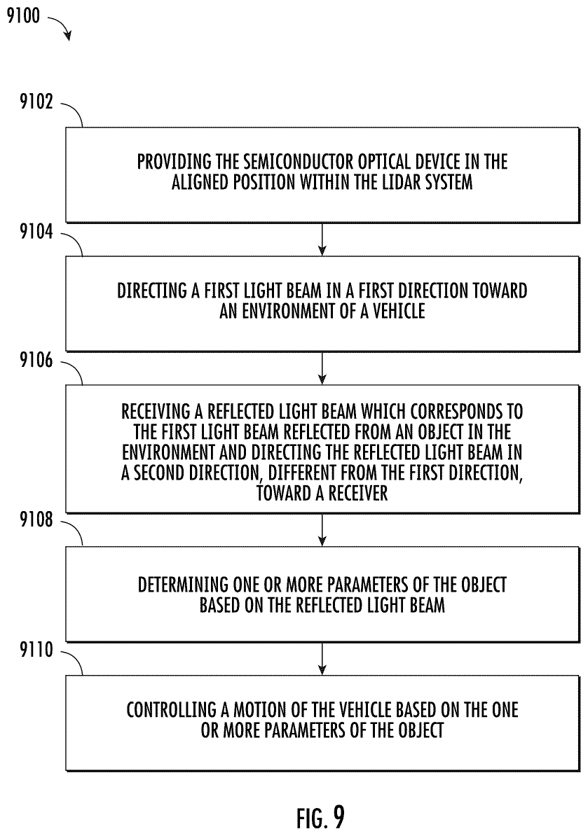

FIG. 9 is a flow diagram of a computer-implemented method 9100 for controlling an autonomous vehicle having a semiconductor-based LIDAR system, according to some implementations of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 9100 may be an extension of the method of FIG. 8. However, in some implementations the method 9100 may be a standalone method (e.g., for testing or implementing a semiconductor optical device in a LIDAR system and/or for controlling a vehicle). Referring to FIG. 9, at operation 9102, the method 9100 includes providing the semiconductor optical device in the aligned position as described in reference to previous figures. For example, the semiconductor optical device may be provided in the aligned position after performing the operations of FIG. 8 which can include one or more heating processes (e.g., a local heating process, a global heating process, etc.).

At operation 9104, the method 9100 includes directing a first light beam in a first direction toward an environment of the vehicle. For example, the first light beam may correspond to outgoing light transmitted via the transmitter 220 in FIG. 2 to the object 218.

At operation 9106, the method 9100 includes receiving a reflected light beam which corresponds to the first light beam reflected from the object in the environment toward a receiver (e.g., receiver 222 in FIG. 2). For example, the reflected light beam may correspond to incoming light which has been reflected off object 218 which may be in an environment of the vehicle. Further, the incoming light may be directed toward receiver 222 in FIG. 2.

At operation 9108, the method 9100 includes determining one or more parameters of the object based on the reflected light beam. For example, as described herein, one or more parameters of the object (e.g., object 218) can be determined based on sensor data collected by the LIDAR system. For example, the LIDAR system may output sensor data 104 which can be processed by one or more sub-control system(s) 101 shown in FIG. 1 to determine the parameters of the object. For example, the parameters of the object can include location data associated with the object, distance information associated with the object, identification or classification information associated with the object, motion information associated with the object, etc.

At operation 9110, the method 9100 includes controlling a motion of the vehicle based on the one or more parameters of the object. For example, as described herein, one or more of the sub-control system(s) 101 shown in FIG. 1 can be implemented to control a motion of the vehicle based on the one or more parameters of the object (e.g., by generating a motion plan, by selecting a motion plan, by controlling braking, acceleration, and/or steering components of the vehicle, etc.).

The foregoing describes the technology of this disclosure within the context of a LIDAR system and an autonomous vehicle for example purposes only. As described herein, the technology described herein is not limited to a LIDAR system or an autonomous vehicle and can be implemented for or within other systems, autonomous platforms, and other computing systems.

What is claimed is:

1. A method for manufacturing a semiconductor-based light detection and ranging (LIDAR) system for a vehicle, the method comprising:
providing a first optical component with a through-hole disposed in a central portion of the first optical component and solder disposed on a first portion of the first optical component which is adjacent to the through-hole;
providing a second optical component;
coupling the first optical component to the second optical component in an alignment operation in which the second optical component at least partially covers the through-hole, wherein after the alignment operation, the solder disposed on the first portion of the first optical component is not in contact with the second optical component; and
applying heat to the solder to cause the solder to flow toward the second optical component and to come into contact with the second optical component.

2. The method of claim 1, wherein
the first optical component includes a first recess disposed on a first side of the through-hole and a second recess disposed on a second side of the through-hole,
the first portion of the first optical component is disposed on the first side of the through-hole, and
the first optical component includes additional solder disposed on a second portion of the first optical component which is disposed on the second side of the through-hole.

3. The method of claim 2, wherein the first recess and the second recess border the through-hole.

4. The method of claim 1, wherein
the first portion of the first optical component is an under bump metal pad,
an area of the under bump metal pad is smaller than an area of the solder before the heat is applied to the solder, and
the area of the under bump metal pad is substantially the same as the area of the solder after the heat is applied to the solder.

5. The method of claim 1, wherein
the first optical component includes a first recess bordering a first side of the through-hole and a second recess bordering a second side of the through-hole,
solder is disposed at a first plurality of locations in the first recess, and
additional solder is disposed at a second plurality of locations in the second recess.

6. The method of claim 1, wherein applying the heat to the solder causes the solder to spread on a metal trace disposed on a surface of the second optical component, and to move into a gap between the first optical component and the second optical component via a capillary force.

7. The method of claim 1, wherein
the first optical component includes a first recess disposed on a first side of the through-hole and a second recess disposed on a second side of the through-hole, and
the alignment operation comprises aligning the first optical component with the second optical component using a first plurality of mechanical stops disposed in the first recess and a second plurality of mechanical stops disposed in the second recess.

8. The method of claim 7, wherein
a first mechanical stop among the first plurality of mechanical stops is disposed adjacent to the first portion of the first optical component,
a height of the first mechanical stop is greater than a height of the solder before the heat is applied to the solder, and
the height of the first mechanical stop is substantially the same as the height of the solder after the heat is applied to the solder.

9. The method of claim 1, wherein the first optical component includes a silicon photonics integrated circuit chip and the second optical component includes a laser diode array chip.

10. The method of claim 9, further comprising coupling a first heat spreader to a first side of the laser diode array chip,
wherein the alignment operation comprises a flip chip operation comprising:
flipping over the laser diode array chip having the first heat spreader coupled thereto,
coupling a second heat spreader to a second side of the laser diode array chip, and
coupling the silicon photonics integrated circuit chip to the laser diode array chip by inserting the laser diode array chip having the first heat spreader and the second heat spreader coupled thereto, in the through-hole.

11. The method of claim 10, wherein a surface area of a side of the first heat spreader facing the first side of the laser diode array chip is greater than a surface area of a side of the second heat spreader facing the second side of the laser diode array chip.

12. The method of claim 1, wherein applying the heat to the solder comprises locally heating the first portion of the first optical component.

13. The method of claim 1, wherein applying the heat to the solder comprises globally heating the first optical component.

14. A light detection and ranging (LIDAR) system, comprising:
an optical system, comprising:
a first optical component including a through-hole disposed in a central portion thereof, a first recess disposed on a first side of the through-hole, and a second recess disposed on a second side of the through-hole, the first optical component including:
first solder disposed on each of a first plurality of under bump metal pads disposed in the first recess,
second solder disposed on each of a second plurality of under bump metal pads disposed in the second recess,
one or more first mechanical stops disposed adjacent to each of the first plurality of under bump metal pads, and
one or more second mechanical stops disposed adjacent to each of the second plurality of under bump metal pads; and
a second optical component coupled to the first optical component and at least partially covering the through-hole, the second optical component including:
first portions coupled to the first optical component via the first solder and the second solder, and
second portions supported by the one or more first mechanical stops of the first optical component and the one or more second mechanical stops of the first optical component, and
wherein
an area of the first solder is substantially the same as an area of a corresponding under bump metal pad on which the first solder is disposed among the first plurality of under bump metal pads, and
a height of the first solder is substantially the same as a height of at least one mechanical stop of the one or more first mechanical stops extending in a direction toward the second optical component.

15. The LIDAR system of claim 14, wherein the first recess and the second recess border the through-hole.

16. The LIDAR system of claim 14, wherein the first optical component includes a silicon photonics integrated circuit chip and the second optical component includes a laser diode array chip.

17. The LIDAR system of claim 16, further comprising:
a first heat spreader coupled to a first side of the laser diode array chip; and
a second heat spreader coupled to a second side of the laser diode array chip,
wherein the second side of the laser diode array chip faces toward the silicon photonics integrated circuit chip and the first heat spreader is disposed outside of the through-hole.

18. The LIDAR system of claim 14, wherein
the first optical component further includes one or more waveguides, and
the second optical component further includes one or more emitters aligned with the one or more waveguides.

19. An autonomous vehicle (AV) control system for a vehicle, comprising:
one or more processors; and
the LIDAR system of claim 14.

20. An autonomous vehicle, comprising:
an autonomous vehicle control system, the autonomous vehicle control system comprising one or more processors and a light detection and ranging (LIDAR) system, the LIDAR system comprising:
an optical system, comprising:
a first optical component including a through-hole disposed in a central portion thereof, a first recess disposed on a first side of the through-hole, and a second recess disposed on a second side of the through-hole, the first optical component further including:
first solder disposed on each of a first plurality of under bump metal pads disposed in the first recess,
second solder disposed on each of a second plurality of under bump metal pads disposed in the second recess,
one or more first mechanical stops disposed adjacent to each of the first plurality of under bump metal pads, and
one or more second mechanical stops disposed adjacent to each of the second plurality of under bump metal pads; and
a second optical component coupled to the first optical component and at least partially covering the through-hole, the second optical component being configured to emit one or more beams to be directed toward an object in an environment of the autonomous vehicle via the first optical component, the second optical component including:
first portions coupled to the first optical component via the first solder and the second solder, and
second portions supported by the one or more first mechanical stops of the first optical component and the one or more second mechanical stops of the first optical component,
wherein
an area of the first solder is substantially the same as an area of a corresponding under bump metal pad on which the first solder is disposed among the first plurality of under bump metal pads, and
a height of the first solder is substantially the same as a height of at least one mechanical stop of the one or more first mechanical stops extending in a direction toward the second optical component,
a receiver configured to receive a reflected beam from the object and determine an object detection associated with the object; and
an autonomous vehicle controller configured to control the autonomous vehicle based on the object detection associated with the object.
